(19) United States
(12) Patent Application Publication
(10) Pub. No.: US 2025/0131271 A1
(43) Pub. Date: Apr. 24, 2025

(54) METHOD AND SYSTEM FOR INCREMENTAL LEARNING OF MULTIMEDIA RECOGNITION MODEL AND NON-TRANSITORY COMPUTER READABLE STORAGE MEDIUM

(71) Applicant: QNAP Systems, Inc., New Taipei City (TW)

(72) Inventor: Wei-Wei HSIUNG, New Taipei City (TW)

(21) Appl. No.: 18/531,097

(22) Filed: Dec. 6, 2023

(30) Foreign Application Priority Data
Oct. 20, 2023 (TW) 112140249

(51) Int. Cl. G06N 3/084

(52) U.S. Cl. CPC G06N 3/084

(57) ABSTRACT

A method and a system for incremental learning of a multimedia recognition model are provided, which merge multimedia samples collected by a semi-supervised algorithm with the present dataset by using a two-stage clustering method. The multimedia recognition model is optimized by a dynamic margin that is finely adjusted in balanced sampling performed on clusters and sub-clusters.

### BACKGROUND

### 1. Technical Field

The present disclosure relates to the training of a multimedia recognition model. The present disclosure further relates to a method and a system for incremental learning of a multimedia recognition model.

### 2. Description of Related Art

A multimedia recognition model trained according to artificial intelligence technology can be used to recognize multimedia data such as audio, video, or images. For example, the multimedia recognition model can be used to recognize the species of an animal such as a cat or a dog, the identity of a passerby, or the model of a vehicle that appears in the aforementioned multimedia data.

Although the multimedia recognition model has good performance when trained on a manually labeled database, the data in reality have long-tailed distribution, and semi-automatic data collection often encounters the problem of uneven data distribution. Therefore, in the training process, clusters with fewer samples are often trained poorly.

In order to mitigate the problem of uneven data distribution, a common method is to use over-sampling or under-sampling to re-balance the clusters, but there is the problem of over-fitting. Moreover, that method still cannot solve the problem of poor training of the clusters with fewer samples.

### SUMMARY

In order to solve the aforementioned problems of existing techniques, the present disclosure aims to combine balanced sampling and recognition training to optimize the distribution of long-tailed data in feature space, so as to mitigate the problem of poor training for clusters with fewer samples, and at the same time avoid over-fitting.

To address the aforementioned problems, the present disclosure provides a method for incremental learning of a multimedia recognition model, the method comprises: performing clustering according to a plurality of features of a plurality of input multimedia objects and a plurality of multimedia features in a present dataset to generate clustered samples; calculating sub-clusters of each cluster in a plurality of clusters in the clustered samples; performing balanced sampling on each of the sub-clusters to generate balanced samples; and performing the incremental learning of the multimedia recognition model according to the balanced samples, wherein a loss function used in the incremental learning comprises a dynamic margin between the clusters, and wherein the dynamic margin is determined according to a number of samples of each of the clusters and a number of samples of each of the sub-clusters.

The present disclosure further provides a system for incremental learning of a multimedia recognition model, the system comprises: a clustering device, configured for performing clustering according to a plurality of features of a plurality of input multimedia objects and a plurality of multimedia features in a present dataset to generate clustered samples; a balanced sampling device, configured for calculating sub-clusters of each cluster in a plurality of clusters in the clustered samples, and performing balanced sampling on each of the sub-clusters to generate balanced samples; and a multimedia recognition training device, configured for performing the incremental learning of the multimedia recognition model according to the balanced samples, wherein a loss function used in the incremental learning comprises a dynamic margin between the clusters, and wherein the dynamic margin is determined according to a number of samples of each of the clusters and a number of samples of each of the sub-clusters.

In view of the above, the present disclosure adopts semi-supervised multimedia clustering and balanced sampling for the incremental learning of a multimedia recognition model, in which a pre-trained feature extraction model is used to extract the features of input multimedia objects. Two-stage clustering is used to merge duplicate clusters, and then pseudo-labels are set for the clustered samples. Different sampling rates and sample parameters of the balanced sampling are set according to the sample size of the clustered samples to calculate the training loss, so as to provide a better incremental learning multimedia recognition model.

### BRIEF DESCRIPTION OF THE DRAWINGS

The present disclosure can be more fully understood by reading the following descriptions of the embodiments, with reference made to the accompanying drawings.

FIG. 1 is a circuit block diagram of a system for incremental learning of a multimedia recognition model according to an embodiment of the present disclosure.

FIG. 2 is a circuit block diagram of a clustering device according to an embodiment of the present disclosure.

FIG. 3 is a circuit block diagram of a balanced sampling device according to an embodiment of the present disclosure.

FIG. 4 is a circuit block diagram of a multimedia recognition training device according to an embodiment of the present disclosure.

FIG. 5 to FIG. 9 are flowcharts of a method for incremental learning of a multimedia recognition model according to an embodiment of the present disclosure.

FIG. 10 is a schematic diagram of the training of a multimedia recognition model with a static margin.

FIG. 11 is a schematic diagram of the training of a multimedia recognition model with a dynamic margin according to an embodiment of the present disclosure.

FIG. 12 is a circuit block diagram of a system for incremental learning of a multimedia recognition model according to an embodiment of the present disclosure.

### DETAILED DESCRIPTION OF THE EMBODIMENTS

The following embodiments are used for illustrating the present disclosure. A person skilled in the art can easily conceive the other advantages and effects of the present disclosure, based on the disclosure of the specification. The present disclosure can also be implemented or applied as described in different embodiments. It is possible to modify or alter the following embodiments for carrying out this disclosure without contravening its spirit and scope, for different aspects and applications.

It is further noted that, as used in this disclosure, the singular forms “a,” “an,” and “the” include plural referents unless expressly and unequivocally limited to one referent. The phrase “and/or” indicates that a plurality of features, elements, or components are to be taken individually or some of the features, the elements, or the components are to be taken collectively.

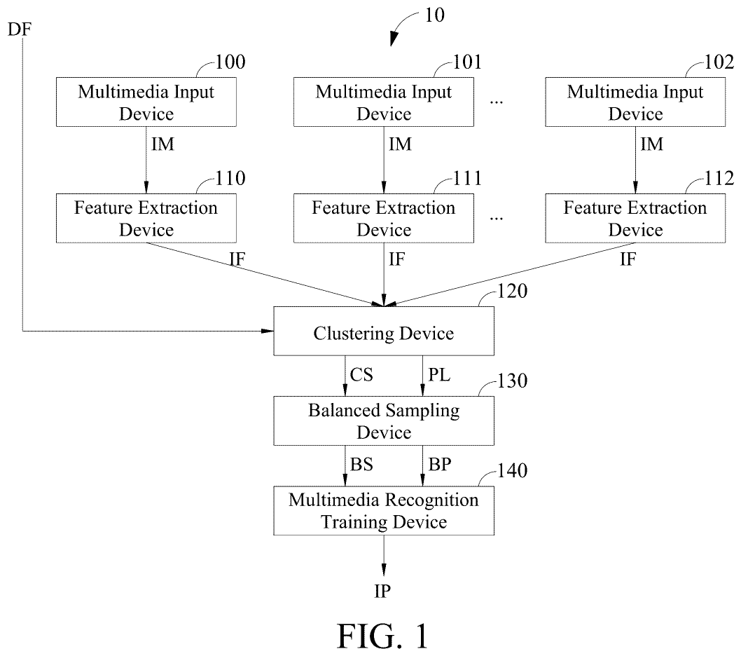

Please refer to FIG. 1, which is a circuit block diagram of a system 10 for incremental learning of a multimedia recognition model according to an embodiment of the present disclosure. In an embodiment, the system 10 for incremental learning of a multimedia recognition model includes a plurality of multimedia input devices (such as the multimedia input devices 100-102 shown in FIG. 1), a plurality of feature extraction devices (such as the feature extraction devices 110-112 shown in FIG. 1), a clustering device 120, a balanced sampling device 130, and a multimedia recognition training device 140. Each feature extraction device 110-112 is electrically coupled to a corresponding multimedia input device 100-102. The clustering device 120 is electrically coupled to each feature extraction device 110-112. The balanced sampling device 130 is electrically coupled to the clustering device 120. In addition, the multimedia recognition training device 140 is electrically coupled to the balanced sampling device 130. In an embodiment, each device shown in FIG. 1 is a physical circuit or an electronic device with data processing capability.

In an embodiment, each multimedia input device 100-102 is used to receive input multimedia objects IM generated or provided by one or more multimedia sources via wired or wireless means. Each input multimedia object IM may be an electronic signal or electronic data, such as an audio clip, a video clip, or an image. A multimedia source may be a camera, a microphone, or a similar electronic device used to generate input multimedia objects IM. Alternatively, a multimedia source may be a network video downloader, a data storage device, a database, or a similar electronic device used to provide input multimedia objects IM. Input multimedia objects of the same cluster is not limited to appearing only in one multimedia source, while input multimedia objects of a cluster may appear repeatedly in different multimedia sources. The multimedia sources may be the same or different databases, such as ImageNet, MS COCO, Google Open Image Dataset, or Mozilla Common Voice Dataset. Each multimedia source may be the same or different hardware, such as a mobile phone, a camera, or a network camera (Internet Protocol camera) with picture-taking functions. The multimedia sources may be positioned in the same or different places, such as building access control cameras, cameras on top of elevators, or automatic teller machine (ATM) cameras.

Next, the feature extraction devices 110-112 receive the aforementioned input multimedia objects IM from the multimedia input devices 100-102 and extract the feature IF of each input multimedia object IM. Next, the clustering device 120 converts the features IF of the input multimedia objects and the multimedia features DF of the present dataset into clustered samples CS and pseudo-labels PL. Next, the balanced sampling device 130 converts the clustered samples CS and the pseudo-labels PL into balanced samples BS and sample parameters BP. Next, the multimedia recognition training device 140 converts the balanced samples BS and the sample parameters BP into an incremental learning multimedia recognition model IP.

The aforementioned feature extraction devices 110-112 extract the features IF of the input multimedia objects IM, wherein the feature extraction model is a model pre-trained using the present dataset. The feature extraction method can use a support vector machine (SVM), a Gaussian mixture model (GMM), a hidden Markov model (HMM) in machine learning, or a convolutional neural network (CNN), an autoencoder, a vision transformer (ViT), a graph convolutional network (GCN) in deep learning, or an equivalent method. The present disclosure is not limited thereto.

The aforementioned present dataset may include multiple pieces of multimedia and their features DF, or include only the features DF extracted from the multiple pieces of multimedia without the multimedia itself. The present dataset may be generated by collection and accumulation by an administrator or a user of the system 10 for incremental learning of a multimedia recognition model, or provided by others.

In an embodiment, there are I multimedia input devices and I corresponding feature extraction devices, and I is a positive integer. The first multimedia input device 100 has M₀ input multimedia objects IM, the second multimedia input device 101 has M₁ input multimedia objects IM, and so on, and the I-th multimedia input device 102 has M_{I-1} input multimedia objects IM. In an embodiment, only one feature is extracted from each input multimedia object IM. Therefore, the first feature extraction device 110 obtains M₀ features IF of the input multimedia objects, the second feature extraction device 111 obtains M₁ features IF of the input multimedia objects, and so on, and the I-th feature extraction device 112 obtains M_{I-1} features IF of the input multimedia objects. The feature extraction devices 110-112 are the same devices that use a model pre-trained with the present dataset to perform the feature extraction.

In another embodiment, at least one feature is extracted from each input multimedia object IM. For example, in a face recognition application, one feature is extracted from each face in each input multimedia object IM (e.g., a photo or a video clip). Therefore, the number of features extracted from each input multimedia object IM is equal to the number of faces in that input multimedia object IM.

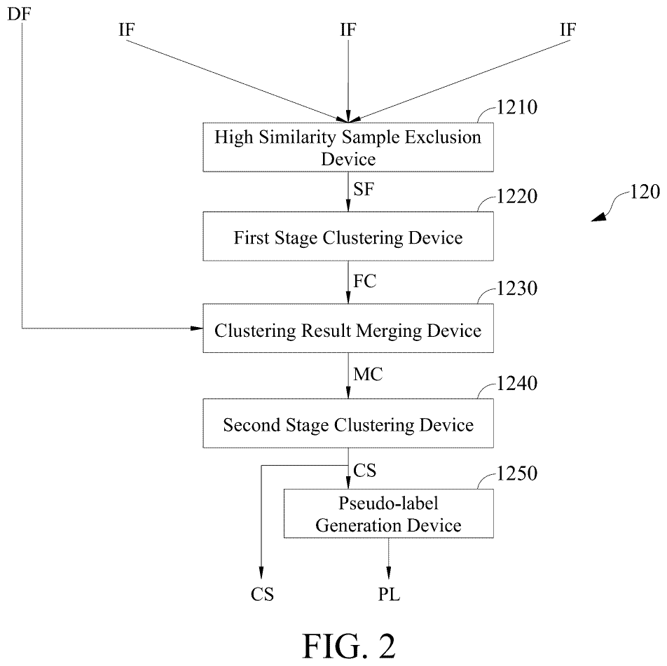

Please refer to FIG. 2, which is a circuit block diagram of the clustering device 120 according to an embodiment of the present disclosure. The clustering device 120 includes a high similarity sample exclusion device 1210, a first stage clustering device 1220, a clustering result merging device 1230, a second stage clustering device 1240, and a pseudo-label generation device 1250, which are electrically coupled in series. In an embodiment, each device shown in FIG. 2 is a physical circuit or an electronic device with data processing capabilities.

The high similarity sample exclusion device 1210 receives the aforementioned features IF of the input multimedia objects, and filters out high similarity samples in the features IF of the input multimedia objects, in order to obtain the filtered samples SF (the samples excluding high similarity). Next, the first stage clustering device 1220 performs the first stage clustering on the filtered samples SF to generate the first stage clustering result FC. Next, the clustering result merging device 1230 merges and converts the multimedia features DF of the present dataset and the first stage clustering result FC into the merged clustering result MC. Next, the second stage clustering device 1240 performs the second stage clustering on the merged clustering result MC to exclude duplicate clusters to obtain the clustered samples CS. Next, the pseudo-label generation device 1250 generates the pseudo-labels PL according to the clustered samples CS.

The aforementioned samples are features IF of the input multimedia objects, and the high similarity samples usually come from the same multimedia source. Therefore, the aforementioned high similarity sample exclusion device 1210, when filtering out the high similarity samples in the features IF of the input multimedia objects, may calculate the distance between each two of the features IF of the input multimedia objects of the same multimedia source. If the distance is less than a threshold value, it means that the two features IF have high similarity, then one of the features IF is excluded and the other one of the features IF is retained. After performing the aforementioned exclusion on the features IF of the input multimedia objects of each multimedia source, the filtered samples SF can be obtained. When calculating the distances between the features IF of the input multimedia objects, a distance calculation method such as Euclidean distance, cosine similarity, or discrepancy alignment metric (DAM), or an equivalent method, may be used. The present disclosure is not limited to these methods.

Next, the aforementioned first stage clustering device 1220 performs clustering on the filtered samples SF. Assuming that the number of features IF of all input multimedia objects is M₀+M₁+ . . . +M_{I-1}, after excluding the samples with high similarity, the retained samples may be divided into N clusters. The clustering method may be density-based spatial clustering of applications with noise (DBSCAN) or graph convolutional network (GCN), such as GCN-V and GCN-E, or an equivalent method. The present disclosure is not limited thereto.

The aforementioned pseudo-label generation device 1250 generates the pseudo-labels PL based on the clustered samples CS, wherein the clustered samples CS include each cluster and the samples in each aforementioned cluster after the aforementioned second stage clustering. Each sample in the clustered samples CS has a corresponding pseudo-label PL, and the pseudo-label PL is equivalent to the identifier of the cluster to which the sample belongs. Therefore, samples in the same cluster have the same pseudo-label PL, while samples in different clusters have different pseudo-labels PL.

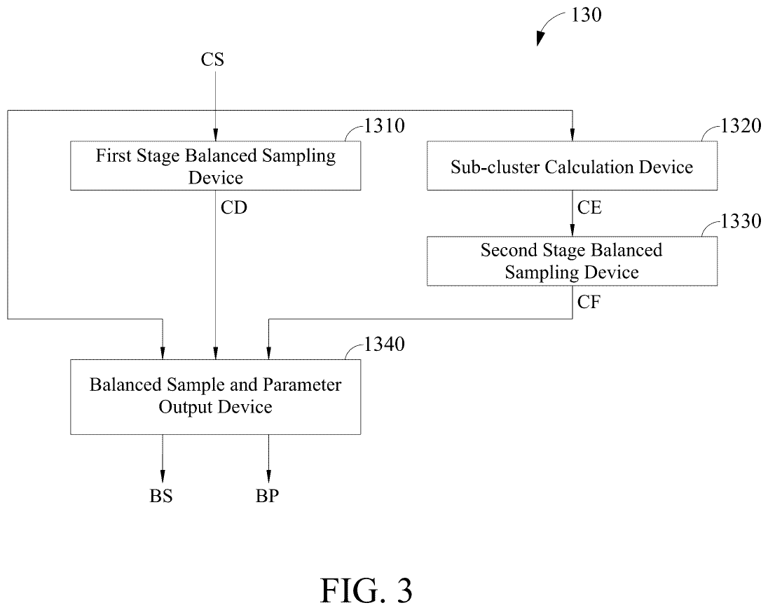

Please refer to FIG. 3, which is a circuit block diagram of a balanced sampling device 130 according to an embodiment of the present disclosure. The balanced sampling device 130 includes a first stage balanced sampling device 1310, a sub-cluster calculation device 1320, a second stage balanced sampling device 1330, and a balanced sample and parameter output device 1340. The second stage balanced sampling device 1330 is electrically coupled to the sub-cluster calculation device 1320. The balanced sample and parameter output device 1340 is electrically coupled to the first stage balanced sampling device 1310 and the second stage balanced sampling device 1330. In an embodiment, each device shown in FIG. 3 is a physical circuit or an electronic device with data processing capability.

The balanced sampling device 130 receives the aforementioned clustered samples CS and pseudo-labels PL. The pseudo-labels PL are used to label the cluster to which each sample belongs in the balanced sampling discussed below. The first stage balanced sampling device 1310 performs balanced sampling on each cluster in the clustered samples CS to obtain the first stage balanced sampling parameter CD. The sub-cluster calculation device 1320 performs clustering on the samples in each cluster in the clustered samples CS to obtain the sub-cluster result CE. The second stage balanced sampling device 1330 performs balanced sampling on each sub-cluster in the sub-cluster result CE to obtain the second stage balanced sampling parameter CF. The balanced sample and parameter output device 1340 converts the clustered samples CS into the balanced samples BS and the sample parameters BP by using the first stage balanced sampling parameter CD and the second stage balanced sampling parameter CF.

The aforementioned balanced sampling performed by the first stage balanced sampling device 1310 on each cluster in the clustered samples CS means that each cluster has the same probability of being sampled. Therefore, each cluster has the same probability of being sampled regardless of the number of samples in the cluster. The balanced sampling method may use over-sampling, under-sampling, or their equivalents. The present disclosure is not limited thereto. The first stage balanced sampling parameter CD includes the results of the first stage balanced sampling of each cluster (e.g., which clusters were sampled) and the number of samples of each cluster. The aforementioned number of samples of each cluster refers to the number of samples of each cluster in the clustered samples CS. The first stage balanced sampling does not change the aforementioned number of samples of each cluster.

When the aforementioned sub-cluster calculation device 1320 performs clustering on the samples in each cluster of the clustered samples CS, the clustering method may be “density-based spatial clustering of applications with noise” (DBSCAN) or graph convolutional network (GCN), such as GCN-V and GCN-E, etc., or an equivalent method. The present disclosure is not limited thereto.

The aforementioned balanced sampling performed by the second stage balanced sampling device 1330 on each sub-cluster in the sub-cluster result CE means that each sub-cluster has the same probability of being sampled. Therefore, the number of samples selected from each sub-cluster is similar or even the same regardless of the number of samples in each sub-cluster. The balanced sampling method may be over-sampling or under-sampling, etc., or an equivalent method. The present disclosure is not limited thereto. The second stage balanced sampling parameter CF includes the results of the second stage balanced sampling of each sub-cluster (e.g., which samples were selected from each sub-cluster) and the number of samples of each sub-cluster. The aforementioned number of samples of each sub-cluster refers to the number of samples of each sub-cluster in the sub-cluster result CE. The second stage balanced sampling selects a portion of the samples from the sampled sub-clusters without changing the aforementioned number of samples of each sub-cluster.

As mentioned above, the balanced sample and parameter output device 1340 generates the balanced samples BS and the sample parameters BP. The balanced samples BS include the samples selected from each sub-cluster in the second stage balanced sampling, while the sample parameters BP include the number of samples of each cluster in the clustered samples CS and the number of samples for each sub-cluster in the sub-cluster result CE.

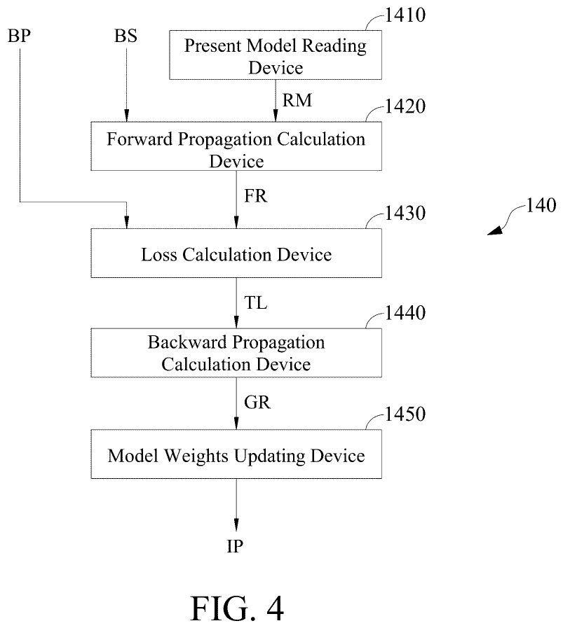

Please refer to FIG. 4, which is a circuit block diagram of the multimedia recognition training device 140 according to an embodiment of the present disclosure. The multimedia recognition training device 140 includes a present model reading device 1410, a forward propagation calculation device 1420, a loss calculation device 1430, a backward propagation calculation device 1440, and a model weights updating device 1450 that are electrically coupled in series. In an embodiment, each device shown in FIG. 4 is a physical circuit or an electronic device with data processing capability.

As mentioned above, the multimedia recognition training device 140 converts the balanced samples BS and the sample parameters BP into the incremental learning multimedia recognition model IP. The present model reading device 1410 is used to read and provide the present multimedia recognition model RM. The present multimedia recognition model RM is the multimedia recognition model previously trained with the present dataset. The forward propagation calculation device 1420 uses the present multimedia recognition model RM to calculate the forward propagation result FR of the balanced samples BS. The loss calculation device 1430 uses the sample parameters BP to calculate the training loss TL of the forward propagation result FR. The backward propagation calculation device 1440 performs backward propagation on the training loss TL to obtain the gradient result GR. The model weights updating device 1450 uses the gradient result GR to update the weights of the present multimedia recognition model RM to obtain the incremental learning multimedia recognition model IP. The aforementioned updating of the weights of the present multimedia recognition model RM is the incremental learning of the present multimedia recognition model RM. The present multimedia recognition model RM after the incremental learning is the incremental learning multimedia recognition model IP. In addition, the model weights updating device 1450 stores the incremental learning multimedia recognition model IP to be read by the present model reading device 1410 as the present multimedia recognition model RM for the next incremental learning. Moreover, the aforementioned forward propagation, training loss, backward propagation and gradient are all well-known terms in the art of neural network. Therefore, the detail of the calculation thereof is omitted here.

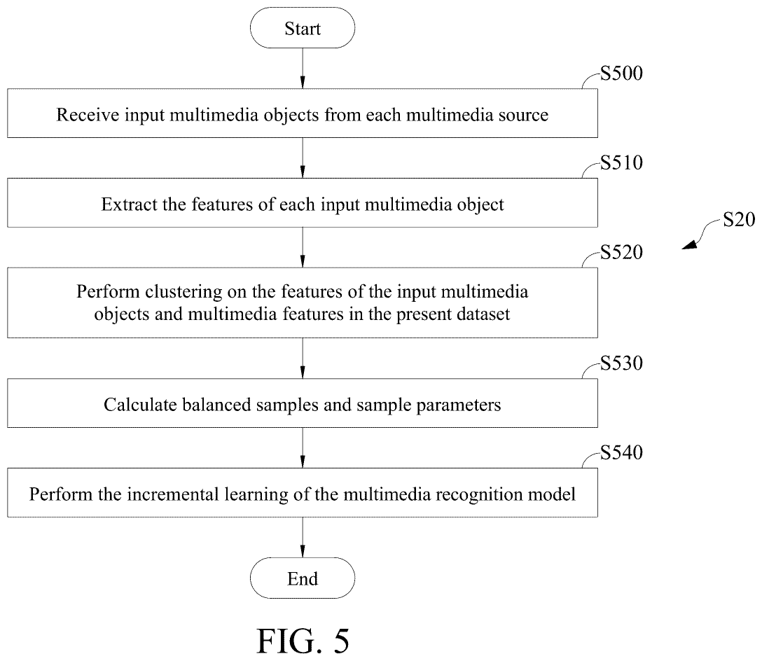

FIG. 5 is a flowchart of a method S20 for incremental learning of a multimedia recognition model according to an embodiment of the present disclosure. The flow of the method S20 is described below with reference to FIG. 5.

Firstly, at step S500, the multimedia input devices 100-102 receive the input multimedia objects IM from each multimedia source.

At step S510, the feature IF of each input multimedia object is extracted by the feature extraction devices 110-112.

At step S520, the clustering device 120 performs clustering on the multimedia features in the present dataset and the features IF of the input multimedia objects to convert the aforementioned features into the clustered samples CS and the pseudo-labels PL in the frequency domain.

At step S530, the balanced samples BS and the sample parameters BP are calculated by the balanced sampling device 130.

Finally, at step S540, the multimedia recognition training device 140 performs incremental learning, i.e., updating the weights of the present multimedia recognition model RM, so as to obtain the incremental learning multimedia recognition model IP.

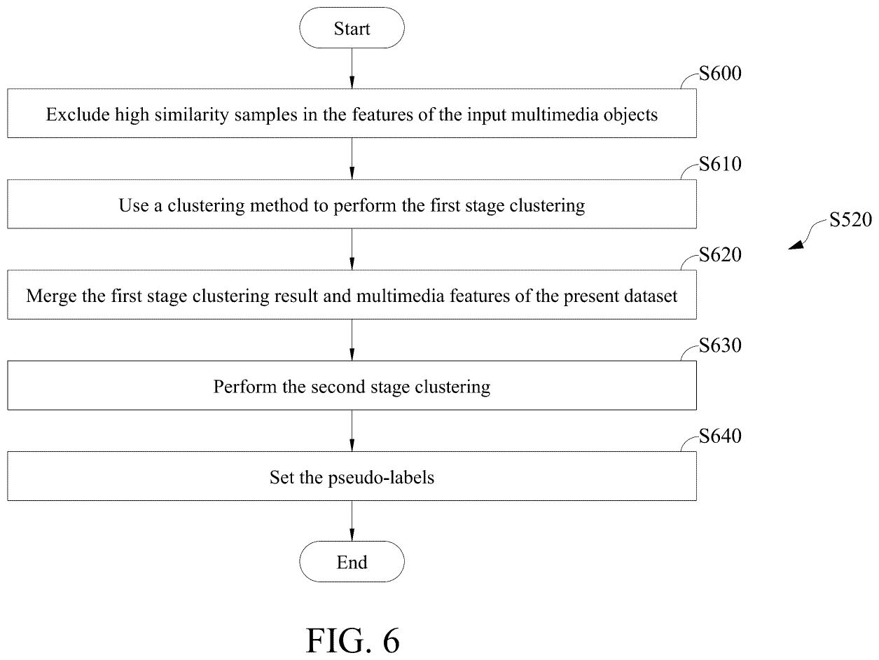

The flow of clustering the feature of each input multimedia object and the multimedia features in the present dataset at step S520 is further described below with reference to FIG. 6.

Firstly, at step S600, the high similarity sample exclusion device 1210 excludes the high similarity samples in the features IF of the input multimedia objects to prevent the duplicated or almost identical samples from interfering the clustering, and then obtains the filtered samples SF.

At step S610, the first stage clustering device 1220 performs clustering on the filtered samples SF to generate the first stage clustering result FC.

At step S620, the clustering result merging device 1230 merges the multimedia features DF of the present dataset and the first stage clustering result FC to obtain the merged clustering result MC. Assuming that the first stage clustering result FC has N clusters and the multimedia features DF of the present dataset have P clusters, the merger will result in N+P clusters.

At step S630, the second stage clustering device 1240 deletes duplicate clusters in the merged clustering result MC to generate the clustered samples CS.

Finally, at step S640, the pseudo-label generation device 1250 obtains the pseudo-labels PL from the clustered samples CS. For example, if there are x samples in a cluster, then the pseudo-label PL of these x samples is set to be Lx, and if there are y samples in a cluster, then the pseudo-label PL of these y samples is set to be L_{y}.

The advantages of the two-stage clustering include reducing the number and the complexity of multimedia features and facilitating the merging of the progressively collected multimedia features and the present dataset.

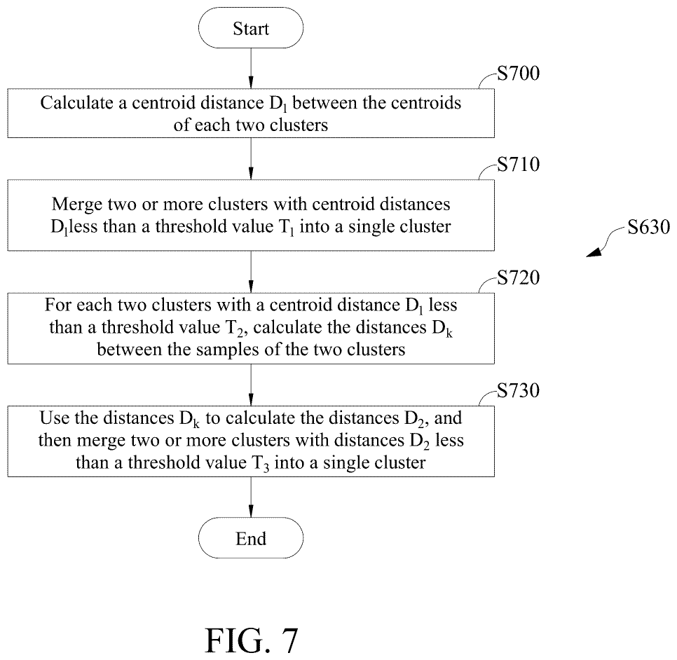

The flow of the clustering of the second stage of step S630 performed by the second stage clustering device 1240 is further described below with reference to FIG. 7.

Firstly, in step S700, calculate a centroid distance D₁ between the centroids of each two clusters in the merged clustering result MC, wherein the centroid distance D₁ may be calculated using a distance calculation method such as Euclidean distance, cosine similarity, or discrepancy alignment metric (DAM).

At step S710, merge two or more clusters with centroid distances D₁ less than a threshold value T₁ into a single cluster. In detail, if there are a total of N+P clusters, the cluster with the largest number of samples is selected as the main cluster, and the clusters whose centroid distances D₁ from the main cluster are less than T₁ in the other N+P−1 clusters are merged into the main cluster, and the aforementioned procedure is repeated for the remaining unmerged clusters.

After the aforementioned merger, there are Q₁ clusters remaining in the merged clustering result MC, wherein Q₁ is less than or equal to N+P. Among these Q₁ clusters, some clusters actually belong to the same cluster, but their centroids are not close enough to be merged into a single cluster.

At step S720, for each two clusters with a centroid distance D₁ less than another threshold value T₂, calculate the distances Dₖ between the samples of the two clusters, wherein T₂ is greater than T₁. Assuming that there are m and n samples in the two clusters, respectively, and then there are a total of m×n distances Dₖ. The method for calculating the distances Dₖ may be any one of the aforementioned centroid distance calculation methods.

In a multi-dimensional feature space, the centroids of different clusters may not be very close to each other, but the samples in the clusters may be very close to each other. Therefore, at step S730, convert the distances between samples to the distances between clusters, i.e., use the distances Dₖ between samples to calculate the distances D₂ between clusters, and then two or more clusters with distances D₂ less than another threshold value T₃ are merged into a single cluster. The merging procedure of clusters at step S730 is similar to that of at step S710. At this moment, there are Q₂ clusters remaining in the merged clustering result MC, wherein Q₂ is less than or equal to Q₁. When calculating D₂ using Dₖ, average-linkage agglomerative, Ward linkage, or other hierarchical clustering distance calculation methods may be used.

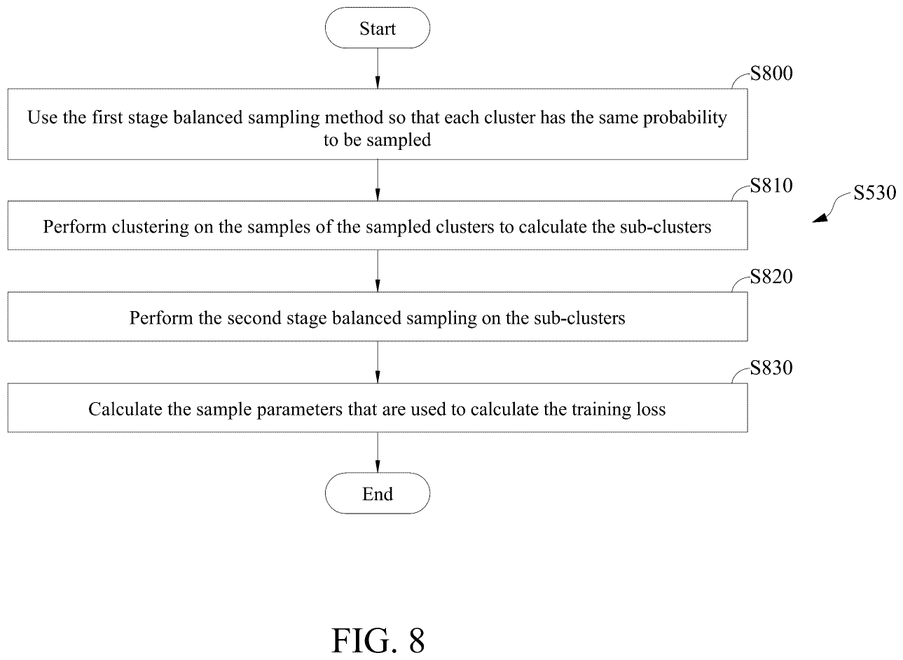

The flow of calculating the balanced samples BS and the sample parameters BP at step S530, which may be performed by the balanced sampling device 130, is further described below with reference to FIG. 8. In an embodiment, each step of the flow of FIG. 8 may be performed by a corresponding device shown in FIG. 3.

Firstly, at step S800, use the first stage balanced sampling method so that each cluster has the same probability to be sampled in order to avoid that clusters with more samples are often sampled and clusters with fewer samples are seldom sampled, which would result in the degradation of the trained multimedia recognition model such that the model is optimal only for clusters with more samples, wherein the balanced sampling method may be a method such as over-sampling or under-sampling.

At step S810, perform clustering on the samples of the sampled clusters to calculate the sub-clusters of the sampled clusters. For example, it is possible that a certain number/segment of audio clips or a certain part of images have a higher degree of similarity. Although these samples belong to the same cluster, the cluster can be divided into two or more sub-clusters. For example, sub-clusters can be calculated using K-means or the DBSCAN method described above. Since the input multimedia objects IM are data collected by semi-supervised clustering, the sample size and diversity may not be sufficient. For example, a certain cluster may only appear frequently from a certain multimedia input device and rarely appear from other multimedia input devices, or the cluster may appear mostly in a certain corner of the image and seldom appear in other positions. This would result in that the data for multimedia recognition training are too simple and the trained model only learns the frequently occurring sample features, and the accuracy of rare samples is low. When the samples in a cluster can be split into several sub-clusters, it means that the number and the diversity of the samples are insufficient.

At step S820, perform the second stage balanced sampling on the sub-clusters, wherein the balanced sampling method may be over-sampling or under-sampling, etc., in order to avoid that the numbers of samples in the sub-clusters are different such that larger sub-clusters are sampled more often, which can manipulate the result of the subsequent multimedia recognition training.

Finally, at step S830, calculate the sample parameters BP that are used to calculate the training loss in the multimedia recognition training described below.

Please refer to both FIG. 3 and FIG. 8, step S800 is executed by the first stage balanced sampling device 1310. Step S810 is executed by the sub-cluster calculation device 1320. Step S820 is executed by the second stage balanced sampling device 1330. Step S830 is executed by the balanced sample and parameter output device 1340. Step S800, step S810 and step S820 can be executed concurrently.

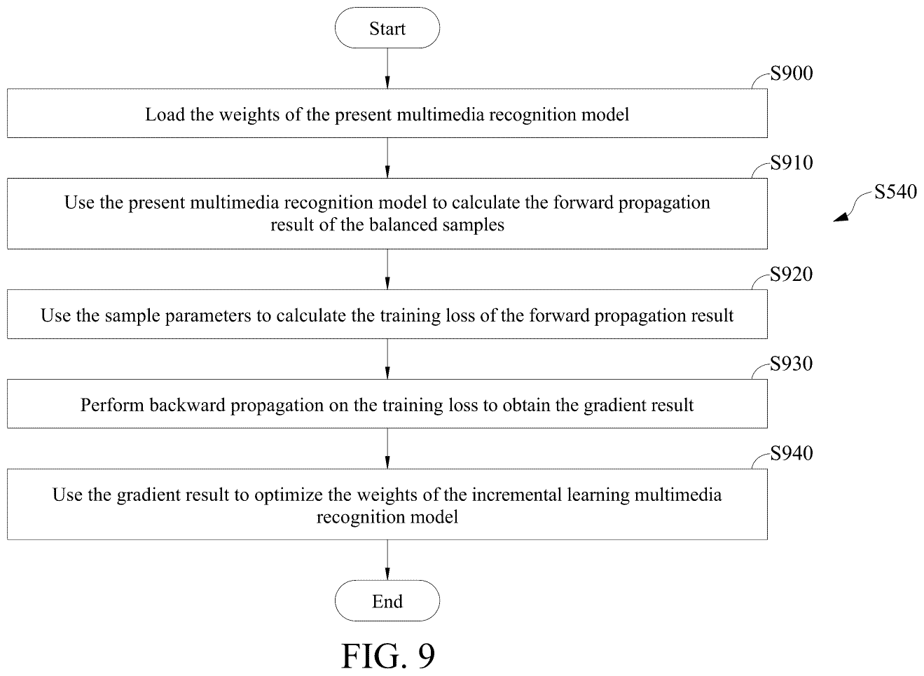

The flow of incremental learning of the multimedia recognition model at step S540 performed by the multimedia recognition training device 140 is further described below with reference to FIG. 9. In an embodiment, each step of the flow of FIG. 9 may be performed by a corresponding device shown in FIG. 4.

Firstly, at step S900, load the weights of the present multimedia recognition model RM, wherein the weights of the present multimedia recognition model RM are obtained from previous training using the present dataset.

At step S910, use the present multimedia recognition model RM to calculate the forward propagation result FR of the balanced samples BS.

At step S920, use the sample parameters BP to calculate the training loss TL of the forward propagation result FR of the balanced samples BS.

At step S930, perform backward propagation on the training loss TL to obtain the gradient result GR.

At step S940, use the gradient result GR to optimize the weights of the incremental learning multimedia recognition model IP. The incremental learning multimedia recognition model IP based on semi-supervised multimedia clustering is better than the present multimedia recognition model RM trained with the present dataset only.

In an embodiment, when the training loss TL of the balanced samples BS is calculated using the sample parameters BP, the training loss TL is designed to adjust the loss of each balanced sample according to the sample parameters BP. In detail, when training a multimedia recognition model, the geodesic distances between the features of each cluster are optimized on a normalized hypersphere. The samples (sample features) in each cluster have to be close to each other, whereas the samples (sample features) in the same cluster have to be far away from the samples (sample features) in the other clusters. In practice, a margin penalty is implemented, and the present disclosure uses the sample parameters BP to adjust the margin penalty of each sample, in order to assign feature spaces of different sizes to the clusters according to the numbers of samples of the clusters, wherein the clusters with insufficient diversity are assigned smaller feature spaces, and the clusters with sufficient diversity are assigned larger feature spaces. A multimedia recognition model trained in this way is better than a traditional model training by assigning a fixed feature space to each cluster. For example, the multimedia input devices 100-102 only receives certain input multimedia objects IM at a fixed time or a fixed location, and the received images or audio clips are always similar, with a low variation of light or angle, resulting in the features IF of the input multimedia objects being too concentrated and lacking diversity in the feature space, which results in the feature distribution degenerating to be close to a point. If a fixed margin is set during the training and the same feature space is assigned to each cluster, the clusters with insufficient diversity would be more scattered in the feature space than the clusters with sufficient diversity would be, resulting in a poorly trained model. Therefore, the present disclosure parameterizes the numbers of samples of the clusters to dynamically adjust the margin, and then assigns feature spaces of different sizes to the clusters, so that the trained multimedia recognition model can perform better for clusters with insufficient diversity.

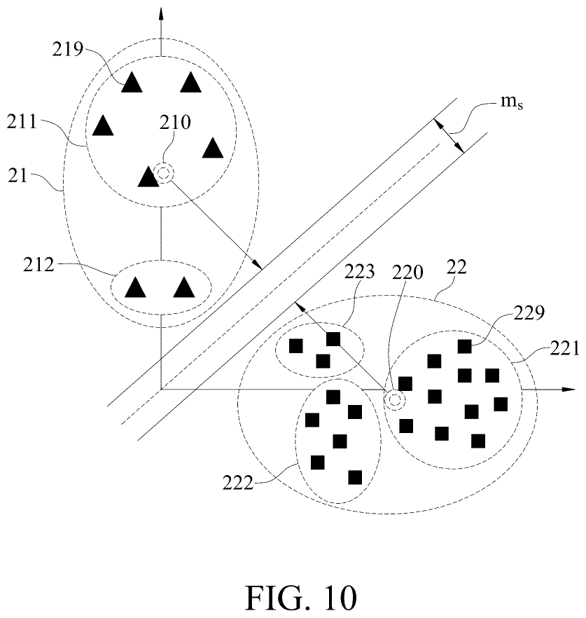

Please refer to FIG. 10, which illustrates an example of performing the aforementioned calculation of the sample parameters BP according to conventional techniques for multimedia recognition training to calculate training loss (step S830) and optimize the weights of the incremental learning multimedia recognition model IP (step S940).

In this example, FIG. 10 illustrates two clusters 21 and 22. The cluster 21 includes two sub-clusters 211 and 212, each of which includes multiple samples. For example, the sub-cluster 211 includes five samples 219. The cluster 22 includes three sub-clusters 221, 222, and 223, each of which includes multiple samples. For example, the sub-cluster 221 includes eleven samples 229. The centroids 210 and 220 are the centroids of the cluster 21 and the cluster 22, respectively. A static margin mₛ is defined between the clusters 21 and 22.

When a multimedia recognition model is optimized in training, the training process minimizes the distances between samples in the same cluster. For example, the samples 219 in the cluster 21 are close to each other and the samples 229 in the cluster 22 are also close to each other. In addition, the training process maximizes the distances between the centroids in different clusters. For example, the centroid 210 of the cluster 21 and the centroid 220 of the cluster 22 are far away from each other. However, the disadvantage of this training is that the centroids cannot represent all samples perfectly, which results in the poor training for clusters with fewer samples. In this case, even though the centroids are already trained to be sufficiently far apart, the samples of different clusters with fewer samples may not be sufficiently far apart. For example, the samples of the sub-cluster 212 and the sub-cluster 223 are still a little close.

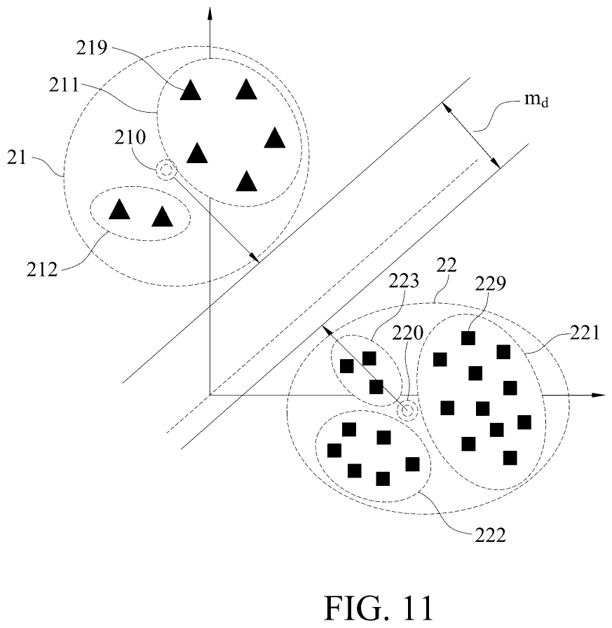

When the technical solution of the present disclosure is applied to the example of FIG. 10, it is shown in FIG. 11. One of the differences between FIG. 11 and FIG. 10 is that a dynamic margin ma instead of a static margin mₛ is defined between the clusters 21 and 22.

The present disclosure specifically performs balanced sampling on sub-clusters, so that the centroids after the balanced sampling are more representative of the centers of the samples of the clusters and the sub-clusters with fewer samples in different clusters can be farther away from each other. For example, the distances from the samples of the sub-cluster 212 to the samples of the sub-cluster 223 in FIG. 11 are longer than those in FIG. 10. In addition, the present disclosure further dynamically adjusts the margin penalty of the loss function for calculating the training loss by assigning smaller feature spaces to clusters with fewer samples, such as the cluster 21, and assigning larger feature spaces to clusters with more samples, such as the cluster 22. In this way, samples of the same cluster can be closer together in the feature space and samples of different clusters can be farther apart.

Taking two loss functions for multimedia recognition training, namely, the CosFace function

$$\frac{{e}^{scos ( {θ}_{{y}_{i}} ) - {m}_{s}}}{{e}^{scos ( {θ}_{{y}_{i}} ) - {m}_{s}} + {\sum }_{j = 1 , j \neq i}^{N} {e}^{scos {θ}_{{y}_{j}}}}$$

and the ArcFace function

$$\frac{{e}^{scos ( {θ}_{{y}_{i}} + {m}_{s} )}}{{e}^{scos ( {θ}_{{y}_{i}} + {m}_{s} )} + {\sum }_{j = 1 , j \neq i}^{N} {e}^{scos {θ}_{{y}_{j}}}}$$

of margin-based softmax cross-entropy as examples, wherein yᵢ is the target cluster, yⱼ is the non-target cluster, s is the radius of the hypersphere, and mₛ is the static margin (or static margin value). The present disclosure uses the sample parameters BP to replace the traditional static margin mₛ with the dynamic margin ma (or dynamic margin value). For example, m_{d}=mₛ+dαβ, wherein d is a constant for controlling the floating range of the dynamic margin, α is a parameter of the first stage balanced sampling,

$$α = 1 - min ( \frac{N}{{N}_{max}} , 1 ) ,$$

wherein N is the number of samples in the cluster, and Nₘₐₓ is a constant. For example, N=7 for the cluster 21. β is a parameter of the second stage balanced sampling,

$$β = 1 - min ( \frac{M}{{M}_{max}} , 1 ) ,$$

wherein M is the number of samples of the sub-cluster and Mₘₐₓ is a constant. For example, M=2 for the sub-cluster 212. The sample parameters BP in this example include N and M.

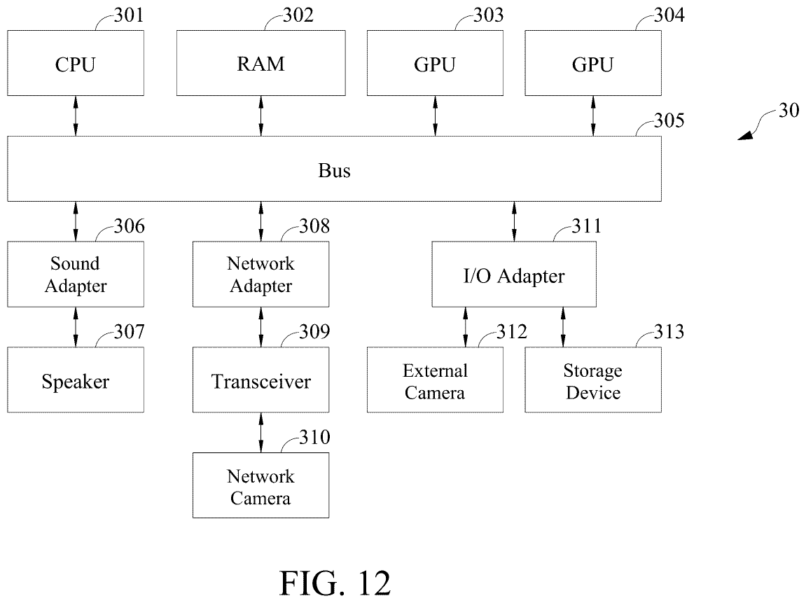

Please refer to FIG. 12, which is a circuit block diagram of a system 30 for incremental learning of a multimedia recognition model according to an embodiment of the present disclosure. The components of the system 30 for incremental learning of a multimedia recognition model include a central processing unit (CPU) 301, a random access memory (RAM) 302, two graphics processing units (GPUs) 303 and 304, a bus 305, a sound adapter 306, a speaker 307, a network adapter 308, a transceiver 309, a network camera 310, an input/output (I/O) adapter 311, an external camera 312, and a storage device 313.

The CPU 301, the RAM 302, the GPUs 303 and 304 are electrically coupled to the bus 305. The CPU 301 is configured to control the other components of the system 30 for incremental learning of a multimedia recognition model. Furthermore, the CPU 301 cooperates with the GPUs 303 and 304 to execute the aforementioned method S20 for incremental learning of a multimedia recognition model. The RAM 302 is configured to store the data required for the execution of the method S20 and the data generated during the execution of the method S20. The bus 305 is configured to transfer signals between the components of the system 30 for incremental learning of a multimedia recognition model.

The sound adapter 306, the network adapter 308, and the I/O adapter 311 are electrically coupled to the bus 305. The speaker 307 is electrically coupled to the sound adapter 306. The transceiver 309 is electrically coupled to the network adapter 308. The network camera 310 is communicatively coupled to the transceiver 309 via wired or wireless network. The external camera 312 and the storage device 313 are electrically coupled to the I/O adapter 311.

The speaker 307 is configured to play sound or audio. The sound adapter 306 is configured to forward and convert signals associated with the speaker 307 between the bus 305 and the speaker 307. The network camera 310, the external camera 312 and the storage device 313 are multimedia sources generating or providing input multimedia objects IM. The storage device 313 may be a non-volatile data storage device such as a non-volatile memory or a hard disk (hard drive) configured for storing the input multimedia objects IM, instructions to be loaded by the CPU 301 and the GPUs 303, 304 for executing the method S20 for incremental learning of a multimedia recognition model, the present multimedia recognition model RM, and the incremental learning multimedia recognition model IP. The transceiver 309 is configured to forward and convert signals associated with the network camera 310 between the network camera 310 and the network adapter 308. The network adapter 308 is configured to exchange network packets with the network camera 310 according to a network communication protocol and through the transceiver 309. The I/O adapter 311 is configured to forward and convert signals associated with the external camera 312 between the bus 305 and the external camera 312, and to forward and convert signals associated with the storage device 313 between the bus 305 and the storage device 313.

In another embodiment, each device shown in FIG. 1 to FIG. 4 may be implemented as a software module that may be stored in the storage device 313 and may be loaded by the CPU 301 and the GPUs 303, 304 for executing the method S20 for incremental learning of a multimedia recognition model. In yet another embodiment, each device shown in FIG. 1 to FIG. 4 may be implemented as a firmware module or a hardware module.

The system 30 for incremental learning of a multimedia recognition model shown in FIG. 12 includes a CPU 301 and two GPUs 303 and 304, but the present disclosure is not limited thereto. In another embodiment, the numbers of CPUs and GPUs of the system 30 for incremental learning of a multimedia recognition model may be adjusted according to demand.

In an embodiment, the present disclosure provides a computer-readable storage medium, such as a memory, a floppy disk, a hard disk, or an optical disk. The computer-readable storage medium stores instructions that can be read by a processor (e.g., a CPU and/or a GPU) of an electronic computing device, such as a computer, for executing the aforementioned method S20 for incremental learning of a multimedia recognition model. In another embodiment, the computer-readable storage medium is a non-transitory computer-readable storage medium.

In view of the above, the present disclosure provides a system for incremental learning of a multimedia recognition model and a corresponding method, which utilizes semi-supervised multimedia clustering and balanced sampling for incremental learning of a multimedia recognition model. The present disclosure adopts two-stage clustering to avoid the data from being too complex for clustering calculation, and to facilitate progressive merging of the collected features of the input multimedia objects with the present dataset. In addition, the present disclosure utilizes the numbers of samples of clusters and sub-clusters to set dynamic margin penalty during balanced sampling, so that feature spaces of different sizes can be dynamically assigned to the clusters to prevent clusters with insufficient diversity from being too dispersed in the feature spaces. The incremental learning multimedia recognition model IP trained in this way is better than a model that assigns a fixed feature space to each cluster and performs better for the clusters with insufficient diversity.

While some of the embodiments of the present disclosure have been described in detail above, it is, however, possible for those of ordinary skill in the art to make various modifications and changes to the particular embodiments shown without substantially departing from the teaching and advantages of the present disclosure. Such modifications and changes are encompassed in the spirit and scope of the present disclosure as set forth in the appended claims.

What is claimed is:

1. A method for incremental learning of a multimedia recognition model, the method comprising:
performing clustering according to a plurality of features of a plurality of input multimedia objects and a plurality of multimedia features in a present dataset to generate clustered samples;
calculating sub-clusters of each cluster in a plurality of clusters in the clustered samples;
performing balanced sampling on each of the sub-clusters to generate balanced samples; and
performing the incremental learning of the multimedia recognition model according to the balanced samples, wherein a loss function used in the incremental learning comprises a dynamic margin between the clusters, and wherein the dynamic margin is determined according to a number of samples of each of the clusters and a number of samples of each of the sub-clusters.

2. The method according to claim 1, wherein the step of performing the clustering according to the features comprises:
among the features of the input multimedia objects, excluding a portion of the features whose interval distances are less than a corresponding threshold;
performing clustering on the features of the input multimedia objects that are not excluded to generate a plurality of input clusters; and
merging the input clusters and a plurality of present clusters formed by the multimedia features of the present dataset, wherein the clusters in the clustered samples are a result of the merging of the input clusters and the present clusters.

3. The method according to claim 2, wherein the step of merging the input clusters and the present clusters comprises:
merging at least two clusters in the input clusters and the present clusters whose interval distance is less than a corresponding threshold, wherein the interval distance is a distance between centroids of the at least two clusters or is calculated according to distances between samples of the at least two clusters.

4. The method according to claim 1, wherein the sub-clusters of each of the clusters are obtained by performing clustering on the features of each of the clusters.

5. The method according to claim 1, wherein the clusters in the clustered samples are clusters selected from all clusters in the clustered samples by balanced sampling with a same probability for each cluster in the clustered samples.

6. The method according to claim 1, wherein the balanced samples comprise features selected from the features in each of the sub-clusters by balanced sampling with a same probability for each of the sub-clusters.

7. The method according to claim 1, wherein the incremental learning of the multimedia recognition model comprises:
using the multimedia recognition model to calculate a forward propagation result of the balanced samples;
using the loss function to calculate a training loss of the forward propagation result;
performing backward propagation on the training loss to obtain a gradient result; and
using the gradient result to optimize weights of the multimedia recognition model.

8. The method according to claim 1, wherein the dynamic margin comprises a product of a first value and a second value, wherein the first value decreases as a number of samples of the cluster corresponding to the loss function increases, and wherein the second value decreases as a number of samples of the sub-cluster corresponding to the loss function increases.

9. A system for incremental learning of a multimedia recognition model, the system comprising:
a clustering device, configured for performing clustering according to a plurality of features of a plurality of input multimedia objects and a plurality of multimedia features in a present dataset to generate clustered samples;
a balanced sampling device, configured for calculating sub-clusters of each cluster in a plurality of clusters in the clustered samples, and performing balanced sampling on each of the sub-clusters to generate balanced samples; and
a multimedia recognition training device, configured for performing the incremental learning of the multimedia recognition model according to the balanced samples, wherein a loss function used in the incremental learning comprises a dynamic margin between the clusters, and wherein the dynamic margin is determined according to a number of samples of each of the clusters and a number of samples of each of the sub-clusters.

10. The system according to claim 9, wherein the clustering device further comprises:
among the features of the input multimedia objects, excluding a portion of the features whose interval distances are less than a corresponding threshold;
performing clustering on the features of the input multimedia objects that are not excluded to generate a plurality of input clusters; and
merging the input clusters and a plurality of present clusters formed by the multimedia features of the present dataset, wherein the clusters in the clustered samples are a result of the merging of the input clusters and the present clusters.

11. The system according to claim 9, wherein the multimedia recognition training device further comprises:
using the multimedia recognition model to calculate a forward propagation result of the balanced samples;
using the loss function to calculate a training loss of the forward propagation result;
performing backward propagation on the training loss to obtain a gradient result; and
using the gradient result to optimize weights of the multimedia recognition model.

12. A non-transitory computer readable storage medium, storing instructions therein, to execute a method for incremental learning of a multimedia recognition model, the method comprising:
performing clustering according to a plurality of features of a plurality of input multimedia objects and a plurality of multimedia features in a present dataset to generate clustered samples;
calculating sub-clusters of each cluster in a plurality of clusters in the clustered samples;
performing balanced sampling on each of the sub-clusters to generate balanced samples; and
performing the incremental learning of the multimedia recognition model according to the balanced samples, wherein a loss function used in the incremental learning comprises a dynamic margin between the clusters, and wherein the dynamic margin is determined according to a number of samples of each of the clusters and a number of samples of each of the sub-clusters.
